(19) United States
(12) Patent Application Publication
(10) Pub. No.: US 2022/0097278 A1
(43) Pub. Date: Mar. 31, 2022

(54) EXTRUSION OR MOLD PROCESS AND ASSEMBLY FOR FORMING A MATERIAL INCORPORATING A STRUCTURAL PLANK INTERIOR IN COMBINATION WITH A POLYMER

(71) Applicant: Neuvotec, LLC, Auburn Hills, MI (US)

(72) Inventor: Miguel A. Linares, Bloomfield Hills, MI (US)

(21) Appl. No.: 17/487,178

(22) Filed: Sep. 28, 2021

Related U.S. Application Data
(60) Provisional application No. 63/084,060, filed on Sep. 28, 2020.

(51) Int. Cl. B29C 48/154; B29C 48/31; B29C 48/156

(52) U.S. Cl. CPC B29C 48/154; B29L 2007/002; B29C 48/156; B29C 48/31

(57) ABSTRACT

An assembly for creating any structural, insulation or decorative article. A plank shaped body is continuously fed through a cross sectional extrusion die for coating at least an exterior of said body with a polymer material. The plastic extrusion formed along opposite side edges of the extruded body can also form interlocking profiles which facilitate edge-to-edge assembly of the completed articles in such as a wallboard, ceiling board or floorboard assembly. Pinch rollers are provided for compressing outer layers of material to the outer polymer coating and are not limited to any of burlap, muslin or canvas, as well as other outer materials like organic/inorganic acoustic dampening materials along with vinyl fabrics which can include both an exterior finished side and an opposite natural side for facilitating adhering to the central extruded polymerized material.

### CROSS REFERENCE TO RELATED APPLICATIONS

The present application claims the priority of U.S. Ser. No. 63/084,060 filed Sep. 28, 2020.

### FIELD OF THE INVENTION

The present invention relates generally to extruding processes and assemblies for creating structural, insulation or decorative articles. More particularly, the present invention discloses an extrusion assembly and corresponding process for forming any of a structural, insulative or decorative article.

In an extrusion type operation, a pre-formed structural plank article is fed through any of a profile extrusion, co-extrusion or other type of crosshead die for coating an exterior of the article with a polymer material (most broadly defined to also include any substance having a molecular structure consisting chiefly or entirely of a large number of similar units bonded together, e.g. many synthetic organic materials used as plastics and resins or natural biopolymers). The die can be configured so that the opposite side edges of the exterior plank coating can further incorporate an interlocking profile for forming particular articles as assemble-able wall, ceiling and floorboards.

Additional variants include the width extending extrusion die being utilized with any arrangement of pinch rollers for concurrently applying one or more outer layers of a separate material about the extruded structural plank article. The separately applied materials are not limited to such as burlap, muslin or canvas, as well as other outer materials like fabric, cloth, burlap, mats, scrim, weaving, mesh, muslin or canvas, as well as other outer materials like film, poly spun vinyl, fabric, cloth laminate, cross-linked foam laminate, scrim, weaving, mats, or mesh, which can include both an exterior finished side and an opposite natural side for facilitating adhering to the central extruded polymerized material or extruded coated plank article. A still further variant envisions utilizing a width arranged blade for incising a wood veneer layer of a given thickness from a rotating log or stem roll and passing the incised layer through the pinch rollers along with the extruded polymer in order to create a further variant of a structural, insulation or decorative article.

Additional variants include extrusion coating of a polymerized material about an exterior of a previously formed three dimensional polygonal (rectangular or others) and/or tubular article, such as which can further incorporate any polymer/composite, sawdust, foam, gypsum or cellulose matrix, as well as a wooden core material, bamboo or any other structure grasses (such as rattan stems, horsetail or reed sticks), ground corn cobs, metal, or composite framework encapsulated within such matrix. Without limitation, the substrate article can be formed by pre-extrusion or other injection molding or other forming process. This can include, without limitation, the formation of the composite material matrix being done inline continuously in a preceding step of the process or in a separate line feeding into the extrusion coating.

### BACKGROUND OF THE RELEVANT ART

The prior art is documented with examples of structural articles which are extruded or otherwise coated with a plastic or other expandable or settable material. One example is depicted in U.S. Pat. No. 9,962,894 to McDonald, which discloses a press for flattening halved bamboo stalks or other workpieces without loss of volume or splintering.

In McDonald, a first mechanical movement is executed by a pushrod drive train, a plurality of spreader bar assemblies press upon the centerline of a workpiece such that the workpiece does not move off of a work surface but is yet not over crushed. Each spreader bar assembly may comprise two spreader bars hingedly attached to a pushrod. The lower end of the pushrod and proximal ends of the spreader bars pin down the workpiece. In a second mechanical movement executed by a crusher bar drive train, the distal ends of the spreader bars are moved outwardly and spread apart the curved walls of the workpiece. In the last phases of a second movement, planar track plates press downwardly upon the workpiece.

US 2019/0111606 to Linares teaches an extruding process and assembly for creating a structural form, and which includes the steps of bundling and conveying a length of an elongated material into an extruder, reshaping a cross section of the bundle in a first stage of the extruder, extruding a material using any combination of heat and pressure around and between the lengths of material, and outputting a finished article having a cross sectional profile in which the materials are structurally supported by the extruded and hardened material. Other steps include an intermediate chilling stage between reshaping and extruding, and for preventing the extruded material from back flowing. The extruded material further includes any of a polymeric or structural foam material and can exhibit any of a rounded, square, rectangular or I beam cross sectional profile.

U.S. Pat. No. 7,147,745, to Slaven, teaches a bamboo building material and process of manufacture. The material includes a plurality of layers each formed of bamboo segments which have been dried and glue coated. The segments are substantially free of outer nodes and husk and inner membrane material prior to application of glue. The longitudinal axes of the segments in each layer are generally parallel to one another, with each layer having segments oriented generally orthogonally with respect to the next adjacent layers thereto. The layers of segments are compressed and bonded together until the glue cures into a single integral structure.

Wellen, U.S. Pat. No. 3,481,818 teaches a laminated sheet structure having an extruded styrene plastic core sheet having fused to both surfaces a biaxial oriented styrene film. The combined film sheets and extruded sheets are forced between a pair of juxtaposed rollers, with the lower roller of the pair having embossed projections pressed into one side of the laminate sheet.

U.S. Pat. No. 4,504,338 to Ives teaches the formation of aromatic polymer materials, such as composite foamed thermoplastic resin articles and which includes compressing the mixture to increase its density and remove voids, the preform then being formed in a foamed structure under heat.

Hanson US 2010/0038037 teaches an apparatus for applying a film to a bottom side of an extruded sheet including an extruder assembly and a roll stack assembly for forming the sheet, A first station upstream from the roll stack assembly applies a film to the bottom side of the extruded sheet.

Krumm, U.S. Pat. No. 4,304,622, teaches an apparatus for producing slabs of thermoplastic resin material including a pair of extruders for extruding a half-slab strand of a respective roller assembly. The roller assemblies including final rollers which form a consolidation nip between them in which the two half slabs are bonded together. The half slabs can be formed with longitudinal compartments which can be filled with a foamed synthetic-resin material.

Rawlinson, U.S. Pat. No. 4,329,196 teaches a heat-sensitive, three-dimensional thermoplastic layer laminated to a thermoplastic substrate by cooling fusion bonding process. In one variant, a grass-like: sheet of low-density polyethylene is fusion bonded to a rigid high-density polyethylene substrate.

Finally, U.S. Pat. No. 5,779,961, to Teutsch, discloses is a process for making a resin extruded lineal profile structure. The profile extends in an axial direction and has a plurality of continuous discrete fiber bundles radially spaced apart and extending longitudinally substantially along the entire length of the structure. A thermoplastic resin directly contacts the respective fiber bundles along the length thereof.

### SUMMARY OF THE PRESENT INVENTION

The present invention discloses any extrusion or corresponding injection molding process for forming any structural, insulation or decorative article without the need of adhesives or pressure/heat operations at the initial article formation stage. In an extrusion type operation, a pre-formed structural plank article is fed through any profile extrusion, co-extrusion or other type of crosshead die for coating an exterior of the article with a polymer material. The crosshead die can be configured so that the opposite side edges of the exterior plank coating can further incorporate an interlocking profile for forming such articles as assemble-able wall, ceiling and floorboards.

The width extending extrusion die is utilized with any arrangement of pinch rollers for concurrently applying one or more outer layers of a separate material about the extruded structural plank article. The separately applied materials are not limited to such as fabric, cloth, burlap, mats, scrim, weaving, mesh, muslin or canvas, as well as other outer materials like film, poly spun vinyl, fabric, cloth laminate, cross-linked foam laminate, scrim, weaving, mats or mesh having both an exterior finished side and/or an opposite natural side for facilitating adhering to the central extrusion coated plank article. Other outer ply materials include carpet, liner or other acoustic dampening material.

Additional variants include extrusion coating of a polymerized material about an exterior of a previously formed three dimensional polygonal (rectangular or others), and/or tubular article, such as which can further incorporate any polymer/composite, sawdust, foam, gypsum or cellulose matrix, as well as any wooden core materials, bamboo or any other structural grasses (such as rattan stems, horsetail or reed sticks), ground corn cobs, metal or composite framework encapsulated within such matrix.

Without limitation, the substrate article can be formed by pre-extrusion or other injection molding or other forming process. This can, without limitation, further include the substrate article being initially formed or pre-formed by any pre-extrusion or other injection molding or other forming process. This can include, without limitation, the formation of the composite material matrix being done inline continuously in a preceding step of the process or in a separate line feeding into the extrusion coating.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 illustrates an extrusion coating process incorporating any type of profile extrusion, co-extrusion or other type of cross head die for receiving a preformed plank structure for coating a polymer material about the plank structure;

FIG. 2 illustrates an extrusion coating process incorporating any of a profile extrusion, co-extrusion or other type of cross head die for receiving a preformed plank structure which is formed in line for coating a polymer material about the plank structure;

FIG. 3 is an illustration of the coated article of FIG. 1 with a variable thickness coating;

FIG. 4 is an illustration similar to FIG. 2 and depicting another alternate outer finished configuration of an exterior extrusion coating with continuous thickness applied to a plank structure;

FIG. 5 is an illustration of a further extrusion coating of a polymeric material applied over an exterior of a previously formed three dimensional rectangular article, such as which can further incorporate a bamboo framework encapsulated within a rigid and expandable foam matrix, with additional variants including extrusion coatings of a polymerized material about an exterior of a previously formed three-dimensional polygonal (rectangular or other), and/or tubular article, such as which can further incorporate any polymer/composite, sawdust, foam, gypsum, ground corn cobs or cellulose matrix, as well as any wooden core materials, bamboo or any other structural grasses (such as rattan stems, horsetail or reed sticks), ground corn cobs, metal or composite framework encapsulated within such matrix, without limitation the substrate article further including being formed by pre-extrusion or other injection molding or other forming process again not limited to the substrate article can be formed by pre-extrusion or other injection molding or other forming process and which can include, without limitation, the formation of the composite material matrix being done inline continuously in a preceding step of the process or in a separate line feeding into the extrusion coating;

FIG. 6 is a variant of the structural, insulation or decorative article of FIG. 5 in which the pre-formed structural article exhibits plural tiers of individually sectioned bamboo lengths;

FIG. 7 illustrates a further variant of structural, insulation or decorative and exteriorly extrusion coated article in which preformed reeds or sliced bamboo is integrated into a plank structure of a rigid foam or adhesive coating structure;

FIG. 8 is an illustration of a further variant of extrusion coating process for use with a previously formed structural or other plank style article and including the extrusion coated material being passed through an arrangement of pinch rollers along with a coarse material such as a burlap, muslin or canvas for pressing the material into the outer coating plastic by the rollers and without the need for separate adhesives;

FIG. 9 illustrates a sub-variant of FIG. 8 and depicting a substitute upper ply material provided as any of a vinyl fabric or fabric wallpaper such as depicting an exposed finished side of the vinyl fabric material in combination with an opposite adhering side for securing to the polymerized extruded material;

FIG. 10 is an illustration similar to FIG. 9 and showing a substitute upper ply material provided as any of a carpet, liner or other acoustic dampening material;

FIGS. 11-13 present illustrations of structural, insulation or decorative coated articles according to each of the formation processes of FIGS. 8-10 and including opposite side edges of the exterior plank coating incorporating an interlocking profile for forming such articles as assemble-able wall, ceiling and floorboards;

FIG. 14 is partial cutaway illustration of a further variant of a structural article including overlapping bamboo sections encapsulated within a rigid foam which is in turn exteriorly coated by an outer polymerized extruded material;

FIGS. 15-16 provide a pair of rotated sectional perspectives of outer extruded coatings applied to insulated foam structural plank articles and each exhibiting interlocking profiles, with FIG. 15 exhibiting outer natural fiber sheets permitting post formation gluing or fastener installation operations, and FIG. 16 illustrating an acoustical carpet, liner, or other acoustic dampening material for sound absorbing/dampening applications;

FIG. 17 is an illustration of a formation process similar to FIG. 8 according to a further variant and illustrating an upper layer of a wood veneer applied to the coated plank article;

FIG. 18 is an illustration of a dual extrusion process for initially forming the plank structure utilizing a polyethylene foam applied about a raw article not limited to positioned lengths of bamboo, combined with a second process for exterior coating the polymerized material about the plank article in combination with the pinch rollers for assisting in applying an outer material such as including and not limited to any of a burlap, muslin or canvas for pressing the material into the outer coating plastic by the rollers and without the need for separate adhesives;

FIG. 19 is a further variant providing for extrusion coating of a polymerized material about an exterior of a previously formed three-dimensional rectangular article, such as which can further incorporate a bamboo framework encapsulated within a rigid and expandable foam matrix;

FIG. 20 is an illustration further variant providing for extrusion coating of a polymerized material about an exterior of a previously formed I beam cross sectional shaped article, such as which can further incorporate bamboo lengths encapsulated within a rigid and expandable foam matrix;

FIG. 21 is an illustration of a further variant providing for extrusion coating of a polymerized material with a textured or embossed outer pattern about an exterior of a previously formed panel shaped or walkway defining structural article, such as which can further incorporate a bamboo framework encapsulated within a rigid and expandable foam matrix;

FIG. 22 is an illustration of a further variant providing for extrusion coating of a polymerized material about a circular cross sectional shaped and interiorly hollow structural article, such as which can be encapsulated within a rigid and expandable foam matrix;

FIG. 23 is an illustration of a further variant providing for extrusion coating of a polymerized material about a circular cross sectional shaped and including a length of any of a bamboo article or coextruded hollow tubular structure such as which can be encapsulated within a rigid and expandable foam matrix;

FIG. 24 is an illustration of a further variant providing for extrusion coating of a polymerized material about a square, rectangular or other polygonal cross sectional shaped and including a length of a bamboo article or coextruded hollow tubular structure such as which can be encapsulated within a rigid and expandable foam matrix;

FIG. 25 is an illustration of a further variant providing for extrusion coating of a polymerized material about an arrayed plurality of bamboo articles or other coextruded hollow tubular structures such as which can be encapsulated within a rigid and expandable foam matrix; and

FIG. 26 is a related variant to that depicted in FIG. 25 and showing a circular cross sectional article according to a still further variant and providing for extrusion coating of a polymerized material about an arrayed plurality of bamboo articles or other coextruded hollow tubular structures such as which can be encapsulated within a rigid and expandable foam matrix.

### DETAILED DESCRIPTION OF THE PREFERRED EMBODIMENTS

With reference to the attached illustrations, the present invention discloses an extruding process and assembly for coating a previously formed structural plank article. As will be further described, the present invention envisions a variety of formation techniques and applications for coating the structural, insulation or decorative articles exhibiting a variety of different properties. Without limitation, this can also include substituting injection molding or other polymerized formation applications additional to the extrusion formation processes described and illustrated and in order to create an article exhibiting the desired properties.

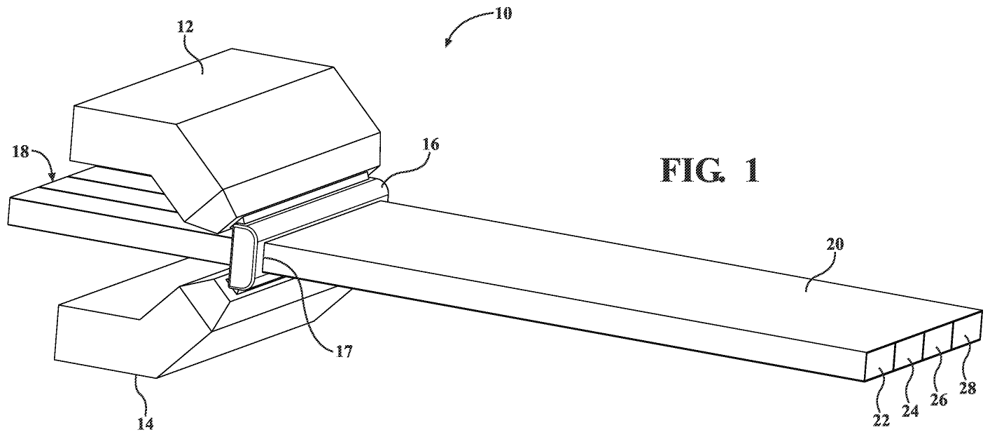

With reference to FIG. 1, an extrusion coating process is generally shown at 10 incorporating a pair of upper 12 and lower 14 manifolds in communication with any perimeter extending and profile extrusion, co-extrusion or other type of crosshead die 16 for receiving a preformed plank structure (see as further generally depicted at 18) for coating a polymer material 20 about a three dimensional exterior of the plank structure. The crosshead die 16 according to this configuration defines a continuous and perimeter configured nozzle 17 through and between which passes the plank structure 18 in a continuous conveyed fashion (through the application of any type of support rollers or other advancing mechanism integrated into the line formation process) and in order to applying the continuous coating of polymerized material.

Without limitation, the profile extrusion, co-extrusion or crosshead die arrangement is supplied by a separate source of a heated and flowable polymer not limited to any of a polyurethane, polypropylene or other composite material, and which can further include a suitable network of conduits lines and heaters for preparing and delivering the extruded material in a desired continuous and nozzle injection profile. The profile extrusion, co-extrusion or crosshead die 16 and associated manifolds 12/14 can also incorporate any combination of heaters and thermocouples (not shown) for coating the plank structure 18 with the polymerized material and for producing a panel or board article exhibiting superior properties of strength combined with lighter weight. Also not shown are any arrangement of cooling tanks or chillers which can be utilized to assist in the controlled application of the plastic about the exterior of the plank structure and in order to provide a consistent polymer coating.

A plurality of individual subset planks 22, 24, 26 and 28 are arrayed in a closely spaced and elongated aligning fashion so that the polymerized die injected material can coat (at 20) both the exterior sides as well as optionally being additionally injected between the aligning subset planks 22, 24, 26 and 28 to provide a scalloped finish.

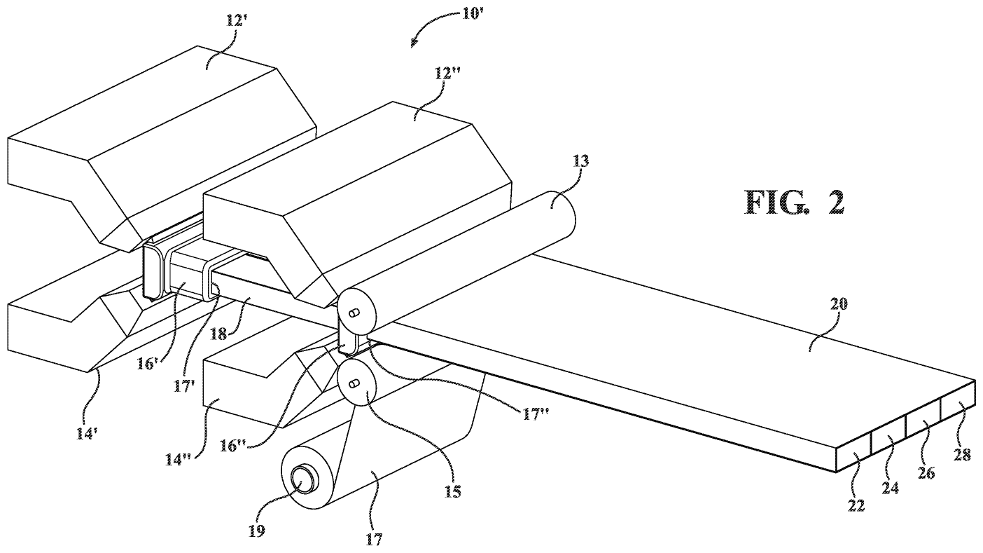

FIG. 2 illustrates a modified extrusion coating process, generally at 10′, incorporating any of a profile extrusion, co-extrusion or crosshead die 16′ for receiving a preformed plank structure which is formed in line for coating a polymer material about the plank structure. As shown, the process 10′ provide first and second pairs of upper 12′/12″ and lower 14′/14″ manifolds in respective communication with first 16′ and second 16″ perimeter extending profile extrusion, co-extrusion or other crosshead dies for receiving a preformed plank structure (see again as further generally depicted at 18) for coating a polymer material 20 about a three dimensional exterior of the plank structure.

As with the variant of FIG. 1, the profile extrusion, co-extrusion or other type of crosshead dies 16′/16″ according to this configuration can again define continuous and perimeter configured nozzles 17′ and 17″ through and between which passes the plank structure 18 in a continuous conveyed fashion and in order to applying the continuous coating of the polymerized material 20. A pair of upper 13 and lower 15 rollers can be provided on an outlet side of the second profile extrusion, co-extrusion or other crosshead die 16″ for assisting in adhering both the polymerized material 20 on an upper side of the article in combination with a suitable roll material 17 (again not limited to any fabric, cloth, burlap, mats, scrim, weaving, mesh, muslin or canvas as well as other materials like film, poly spun vinyl, fabric, cloth laminate, cross-linked foam laminate, scrim, weaving, mats or mesh) unwound from a spindle 19 in lower proximity to the second profile extrusion, co-extrusion or other type of crosshead die 16″.

Without limitation, the substrate articles described herein can be formed by pre-extrusion or other injection molding or other forming process. This can, without limitation, further include the substrate article can be formed by any other type of pre-extrusion or other injection molding or other forming process. This can again include, without limitation, the formation of the composite material matrix being done inline continuously in a preceding step of the process or in a separate line feeding into the extrusion coating.

As will be further described, and without limitation, the plank structure 18 can include any preformed structure which is conveyed through the profile extrusion, co-extrusion or other crosshead die 16, and which can again include forming a plurality of individual subset planks 22, 24, 26 and 28 arrayed in a closely spaced and elongated aligning fashion so that the polymerized die injected material can coat (at 20) both the exterior sides as well as optionally being additionally injected between the aligning subset planks 22, 24, 26 and 28 to provide a scalloped finish.

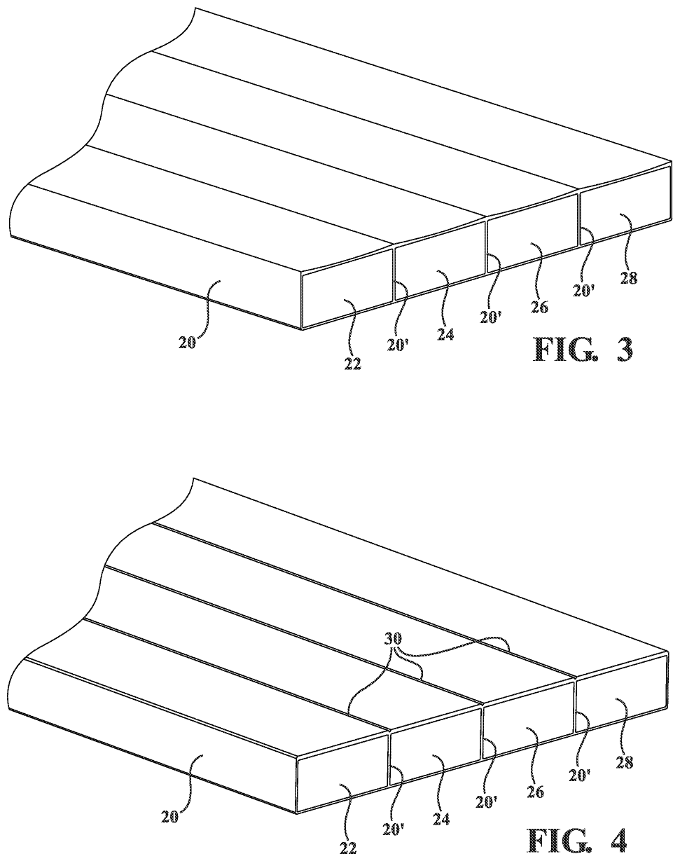

As further depicted in FIG. 3, an illustration of the coated plank article of FIG. 1 is again shown and can include a version in which any of a one piece integrated plank structure can again be reconfigured as a plurality of individual subset planks 22, 24, 26 and 28 which are arrayed in a closely spaced and elongated aligning fashion so that the polymerized die injected material can coat both the exterior sides (again at 20) as well as being additionally injected between the aligning subset planks 22, 24, 26 and 28 (see as represented at 20′ along each opposing interface), such as to provide any transitioning plank thickness. To this end, the configuration of the perimeter configured profile extrusion, co-extrusion or other crosshead die 16 in FIG. 1 can focus the polymer injection nozzles at each width defined interface between each of the closely spaced planks 22-28 to facilitate the formation of the article as shown in FIG. 2. Alternatively, a single width plank can be envisioned for coating with the polymerized material.

FIG. 4 is an illustration similar to FIG. 3 and depicting another alternate outer finished configuration (see recess notches 30 configured along each plank interface 22/24, 24/26 and 26/28 of an exterior extrusion coating 30 applied to a plank structure, this again in combination with the interposed injected plastic 20′ layers applied between each of the planks. The case wall thickness is typically constant around the perimeter and, as will be further described, the individual planks can be constructed of any desired material, such as including a lightweight high blow rigid expandable foam such as which can be utilized in a preformed structure. In one non-limiting application, the planks can be utilized in exterior mounting environments, with the polymerized outer and interior coating layers providing resistance to mold or rotting.

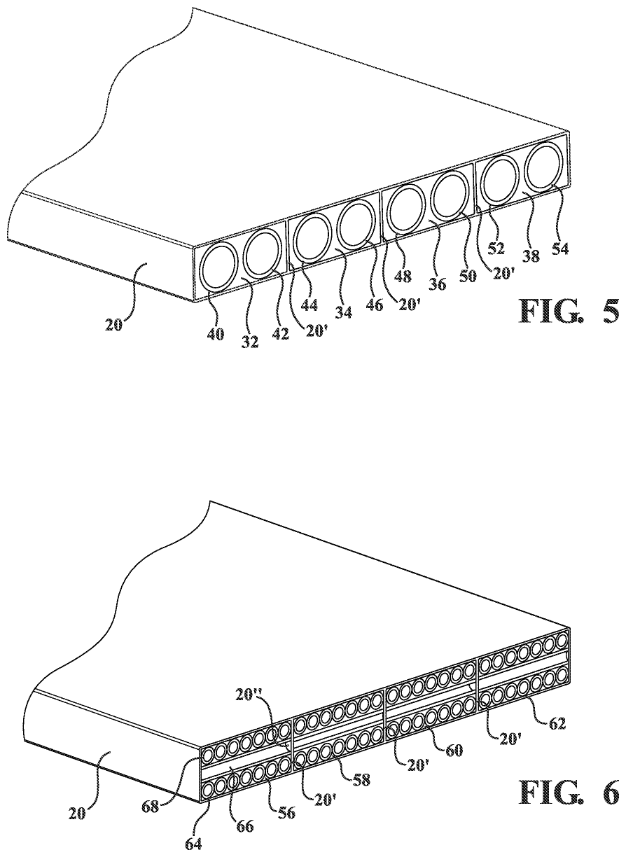

FIG. 5 is an illustration of a further extrusion coating 20 of a polymerized material applied over each of an exterior (as well as injected between segmented interposed boundaries 20′ as shown in each of FIGS. 3-4) of a previously formed three dimensional rectangular article. In this variant, the plank article can further incorporate a bamboo framework encapsulated within one or more elongated sections of a polymeric foam matric which can be any of rigid or expandable.

As further shown, the plank structure is further represented by a plurality of individual planks 32, 34, 36 and 38, each of which again being constructed without limitation from a rigid and expandable foam and each encapsulating a pair of bamboo or other similar configured rods. This is shown by rods 40/42 for subset plank structure 32, rods 44/46 for subset plank structure 34, rods 48/50 for subset plank structure 36 and rods 52/54 for subset plank structure 38.

FIG. 6 is a variant of the structural, insulation or decorative article of FIG. 5 in which the pre-formed structural, insulation or decorative article again is separated into subset plank sections 56, 58, 60 and 62, each of which again including a rigid expandable foam construction and each further incorporating plural tiers of individually sectioned bamboo lengths. By example, first plank section 56 includes arranged tiers 64, 66 and 68 of bamboo or other organic/inorganic rod-shaped members which are configured within the expanded and rigid foam molded matrix 56. As further shown, additional lengths of the bamboo materials can be arranged in a crosswise fashion as between succeeding tiers for providing enhanced strength and, as further illustrated at 66, can be sectioned crosswise so that the interjected boundary plastic layers partially fill the interior of the sectional bamboo (see at 20″).

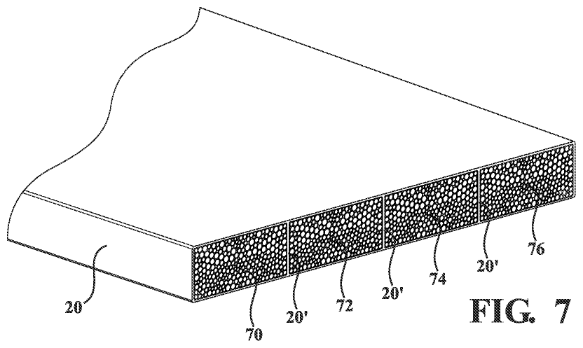

FIG. 7 illustrates a further variant of a structural, insulation or decorative and exteriorly extrusion coated article which can include any of preformed reeds, bamboo plant stakes or sliced bamboo integrated into each individual plank structure, and such as again which can include an expanded rigid foam base matrix. The planks are again representatively depicted as individual portions 70, 72, 74 and 76 and can each further include a rigid foam or adhesive coating structure. As previously described, the planks/individual portions 70-76 can be provided either singularly or in plural and individual aligning fashion and, as shown, can include interjected interior layers of polymerized binder, as again shown at 20′.

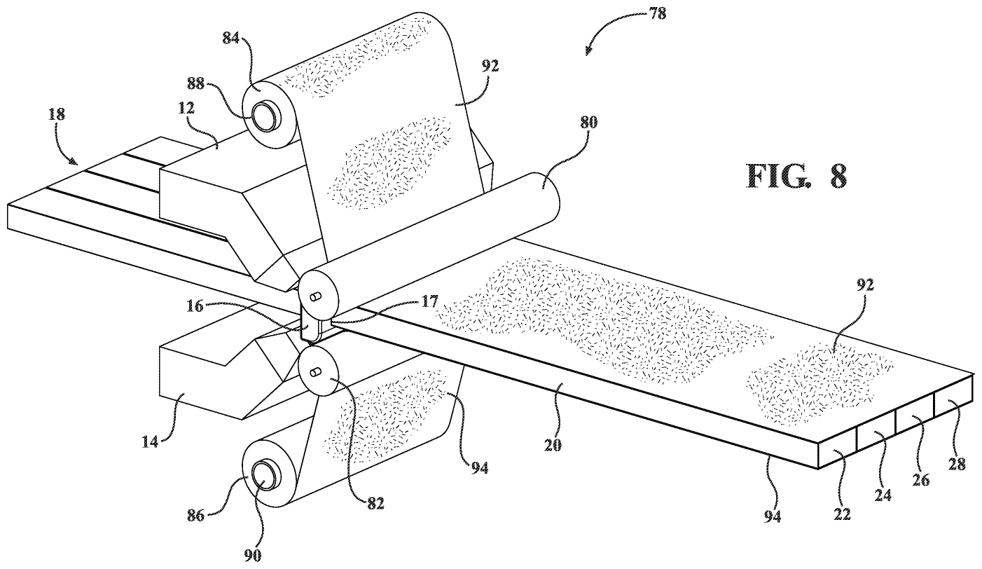

FIG. 8 is an illustration generally at 78 of a further variant of extrusion coating process for use with a previously formed structural or other plank style article and including the extrusion coated plank structure being passed through an arrangement of pinch rollers 80 and 82 along with a coarse material such as a burlap, muslin or canvas for pressing the material into the outer coating 20 of plastic applied to the plank structure 18 by the rollers and without the need for separate adhesives.

Any arrangement of individual and spindle supported rotating pinch rollers are depicted and are depicted as a pair of upper 80 and lower 82 rollers which are positioned forwardly and in relatively close proximity to the width extending nozzle (again at 17) of the profile extrusion, co-extrusion or other type of crosshead extrusion die 16 (see as previously described in FIG. 1). Without limitation, any combination of rollers (including both rotational powered and idled/free rotating) can be provided.

A pair of further ply materials are shown at 84 and 86 and are likewise spindle mounted, see as shown by spindle at 88 for upper positioned roll 84 and by spindle at 90 for lower positioned roll 86, and from which both upper 92 and lower 94 unwound ply material layers are drawn. As further shown, the ply materials 92 and 94 are unwound approximate to the location of the profile extrusion, co-extrusion or other type of crosshead die nozzle 16 and so that, in combination with the appropriately sized and positioned rollers 80 and 82, provides for formation of a structural, insulation or decorative article exhibiting the desired width and cross-sectional properties. This again can include the material properties of the flowable polymerized material being calibrated through the use of thermocouples and site specific heaters (not shown) to allow the die 16 and nozzle 17 to extrude a steady sheet of material which is sufficiently solidified to maintain its dimensional characteristics while being pressed by the rollers 80/82 in order to fuse and embed within the matrix composition of the upper 92 and lower 94 unwound sheets to solidify into a structurally integrated plank product having desired properties of rigidity.

The ply material rolls 84/86 can include any coarse material such as a burlap, muslin or canvas for pressing the material into the molten plastic by the rollers 80 and 82, with roller 80 rotating counterclockwise as shown and opposing roller 82 rotating clockwise a close separation distance to force the molten extruded plastic into the upper 92 and lower 94 unwound ply sheets. In this manner, the extrusion process creates a structural, insulation or decorative article with the coarsened sheets embedded with both upper and lower surfaces of the extruded plastic applied around the plank structure 18, and without the need for separate adhesives.

The sheets can also integrate any natural fibers. The individual sections of planks (see again as previously identified at 22, 24, 26 and 28) can also be glued together or otherwise fabricated according to any downstream operation. This can also include any separate sectioning operation.

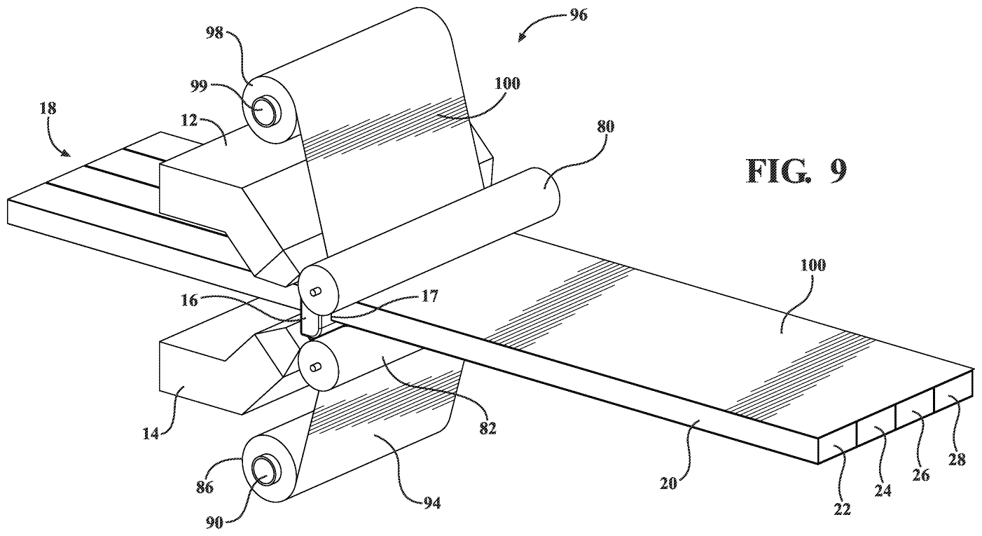

FIG. 9 illustrates a sub-variant of FIG. 8, generally at 96, and depicting a substitute upper play material roll 98 supported by spindle 99 and provided as any of a vinyl fabric or fabric wallpaper such as depicting an exposed finished side of the vinyl fabric material in combination with an opposite adhering side for securing to the polymerized extruded material. Embedding of the outer ply material is again facilitated by pressure or forced bleed-through of the polymerized extrusion coating 20 and without the requirement of adhesives or initial pressure application processes.

Any of the organic or inorganic outer applied layers, not limited to those depicted herein, can include a finished exterior surface and a natural fiber backed inner surface bonded to the inner extruded polymer. By non-limiting application, the finished exterior side can provide the article with a natural look and feel, this in combination with a natural fiber underside backing for providing effective adherence between the layers in response only to the exerted pressure of the rollers which force the polymerized extruded layer into the gaps or crevices within the outer layers of the organic material for providing effective bonding and without the need for separate adhesives or any post formation compression operations.

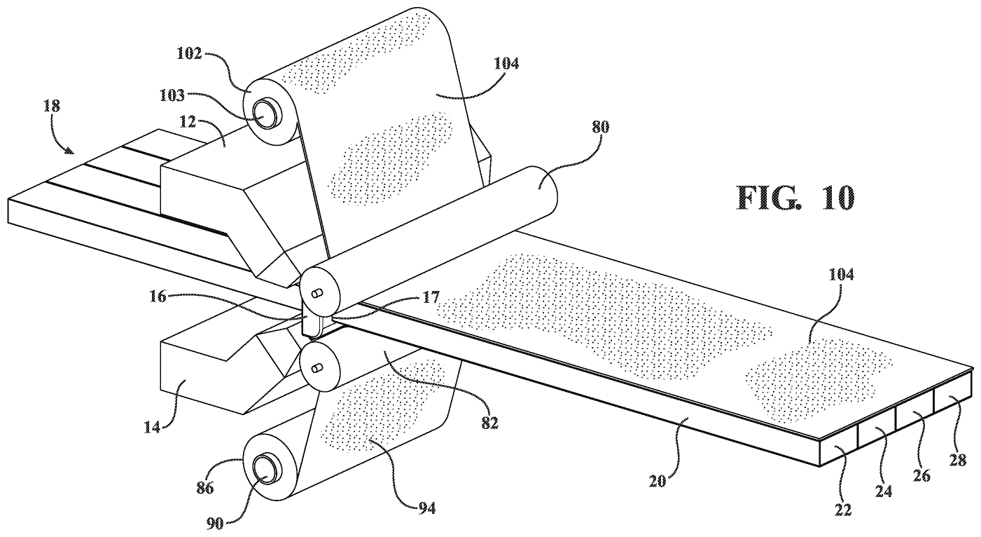

FIG. 10 is an illustration similar to FIG. 9 of a further alternate variant and showing a substitute upper ply material roll 102 supported on spindle 103 and provided as any of a carpet, liner or other acoustic dampening material layer 104 (such as a carpet or upholstery material which can be added to the finished side of the plank surface). Similar to the principles of FIGS. 7-8, the pinch rollers 80/82 operate to force the extrusion coated plastic 20 into the matrix of the upper acoustic layer 104, as well as that of the lower burlap or other coarsened material layer 94 (and which can include any coarsened sheet material such as a paperboard or Kraft layer material).

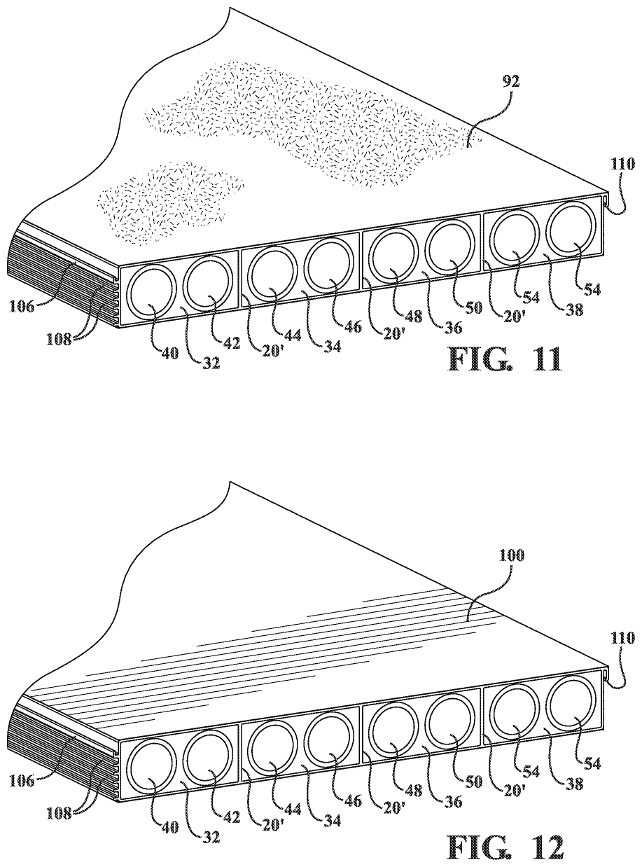

Proceeding to FIGS. 11-13, presented are illustrations of versions of structural coated articles according to each of the formation processes of FIGS. 8-10. Similar to as previously depicted in FIG. 5, the plank article shown in each of FIGS. 11-13 can further incorporate a bamboo framework encapsulated within one or more elongated sections of a rigid and expandable foam matrix, and such as represented by the individual planks 32, 34, 36 and 38, each of which again being constructed without limitation from a rigid and expandable foam and each encapsulating a pair of bamboo or other similar configured rods, further again shown by rods 40/42 for subset plank structure 32, rods 44/46 for subset plank structure 34, rods 48/50 for subset plank structure 36 and rods 52/54 for subset plank structure 38.

Also depicted in each of FIGS. 11-13 are opposite side edges of the exterior plank coating incorporating an interlocking profile for forming such articles as assemble-able wall and floorboards. This is provided by configuring the side injection nozzles associated with the profile extrusion, co-extrusion or other type of crosshead die 16 (see process views FIGS. 1 and 8-10) to extrude plastic in a rapid setting/cooling fashion to define the interlocking structure. The interlocking structure in each of these figures is represented by an angled ledge 106 and parallel spaced and extending spacer portions 108 extruded along a first side edge, this along with a mating and mirror positioned angled ledge 110 extruded along the other side edge.

In this fashion, identical panels according to any of the variations of FIGS. 11-13 can be interlock engaged with one another to form a completed structure for any floorboard, ceiling board or wall board assembly. In the example of FIG. 12, the coarsened layer (such as at 92) can again be provided as a natural fiber and can be applied to both the top and bottom of the extruded article (see again process of FIG. 8), and which in turn facilitating the ability to glue or otherwise secure via conventional fasteners the plank articles to such as a floor joist or other flooring support.

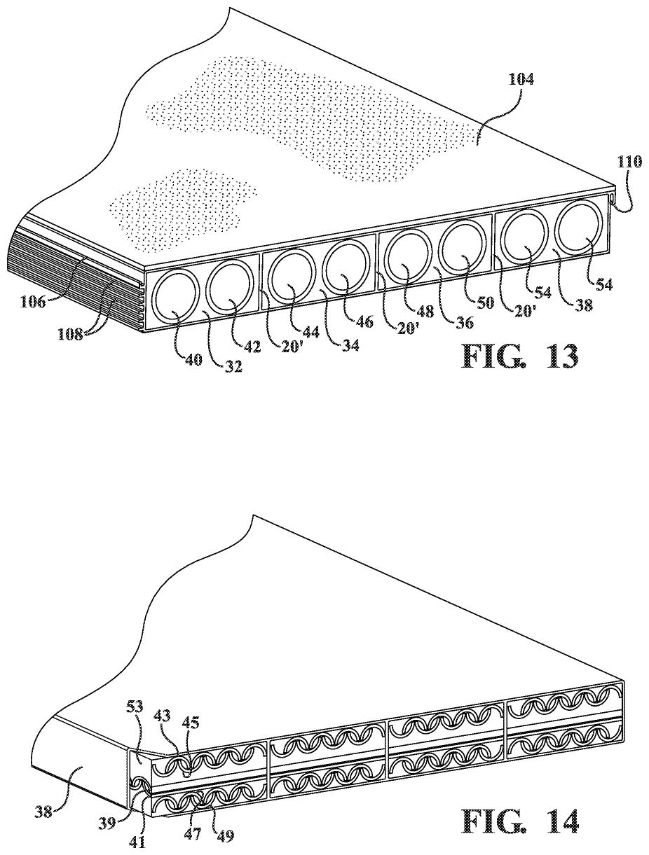

In the example of FIG. 12, the finished article with the vinyl or other finished surfacing layer 100 can include applications such as for insulation or sound proofing wall applications. In the yet further example of FIG. 13, carpet, liner or other acoustic dampening material layer 104 provides a floorboard created article with superior sound dampening properties.

FIG. 14 is partial cutaway illustration of a further variant of a structural article including overlapping bamboo sections encapsulated within a rigid foam which is in turn exteriorly coated by an outer polymerized extruded material. As further shown, individual tiers of opposing positioned bamboo sections 39/41, 43/45, and 47/49 can be arrayed in cross wise extending direction to add strength to the desired finished panel. As depicted, the expandable structural foam 53, upon formation with the individual bamboo sections defining the inner framework of the substrate article, ensures and provides for proper spacing and arraying of the individual bamboo sections. It is also envisioned that the substrate article can be formed by any of a modified extrusion or separate injection molding process.

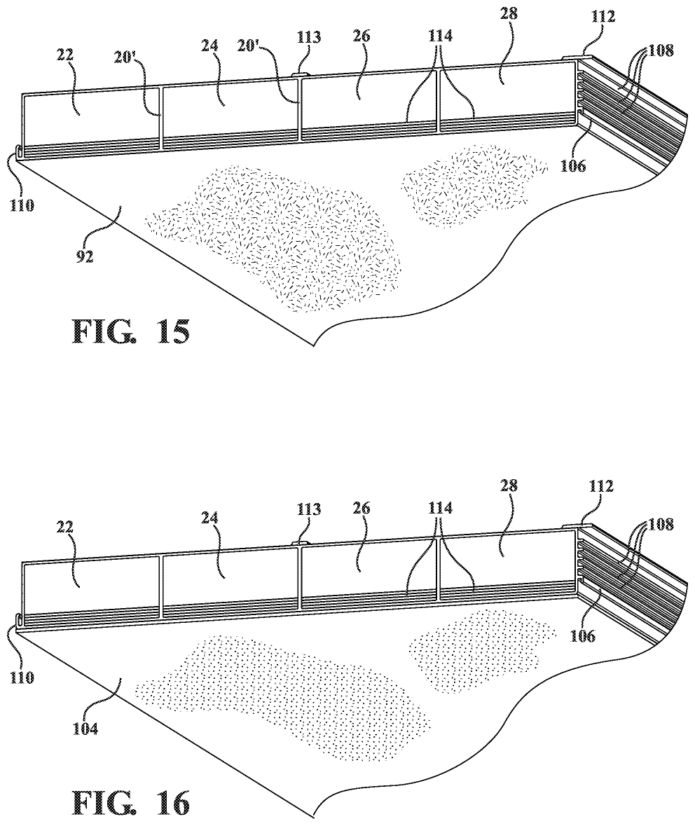

Proceeding to FIGS. 15-16, provided are a pair of rotated sectional perspectives of outer extruded coatings applied to other variations of insulated foam structural plank articles. The articles can again include individual lengths or sections of a rigid expanded foam material, again at 22, 24, 26 and 28. The configuration of the extrusion die 16 can be further modified to adapt the polymerized coating in thickness and configuration in order to adapt to a desired application. This can include thickening the formation of an upper ledge profile 112 along the first side and which provides, in combination with an intermediate protrusion 113, a seamless upper edge profile when secured to the ceiling.

In the instance of FIG. 15, the completed article can include an upper natural fiber surface (hidden from view) such as for allowing for gluing or otherwise, securing to a ceiling location, in combination with a lower natural fiber surface (again at 92) for facilitating attachment of any of drywall through the use of any of adhesives, screw fasteners and the like. The extruded plastic can be varied in thickness at different locations (see at 114 in each of FIGS. 15-16). The interlocking profile features previously described (again at 106-112) also permit post formation gluing or fastener installation operations.

FIG. 16 is a substantially identical representation to FIG. 15 and illustrates an acoustical carpet, liner or other acoustic dampening layer (again at 104) for sound absorbing/dampening applications such as applying to a wall or ceiling of larger area rooms in order to provide for superior sound and acoustic dampening.

The extruded interlocking edge profiles are again shown in similar fashion to FIG. 13 and by which a plurality of the individual plank or board style articles can be assembled in edge-to-edge fashion as previously described. This again includes the interlocking structure in each of these figures being represented by an angled ledge 106 and parallel spaced and extending spacer portions 108 extruded along a first side edge (along with the upper ledge profile 112), this along with a mating and mirror positioned angled ledge 110 extruded along the other side edge.

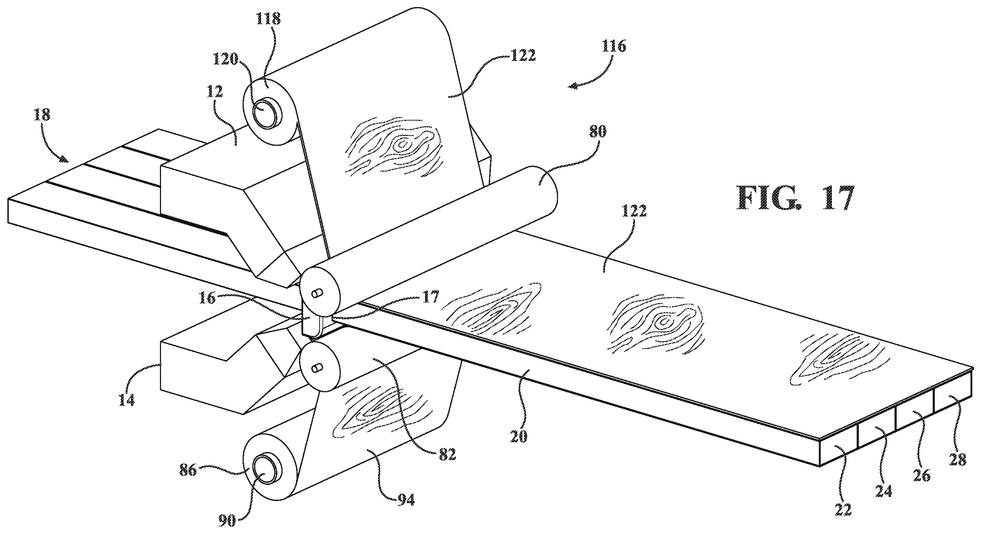

Proceeding to FIG. 17, an illustration is generally shown at 116 of a formation process similar to FIG. 7 according to a further variant, and by which the upper coarse layer 92 in FIG. 7 is substituted by an upper roll 118 (supported on spindle 120) of a wood veneer material, such that an unwound layer 122 of the wood veneer is applied to the coated plank article as shown and in a similar fashion. Without limitation, the wood veneer may be applied to the structural plank or board material 18 and can exhibit any of a plain, fabric or adhesive backing.

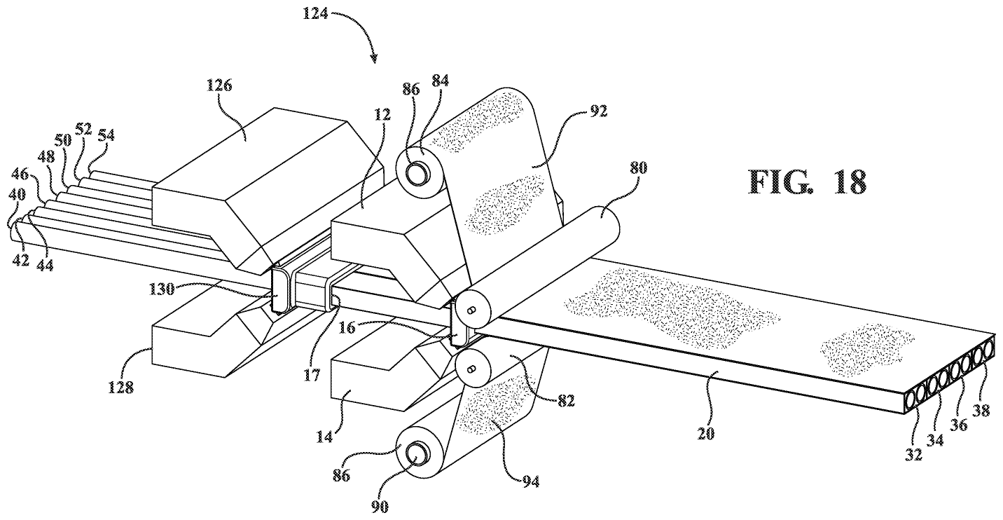

FIG. 18 is an illustration generally shown at 124 of a further version of the dual extrusion process according to a further embodiment for both initially forming the underlying plank structure and, following that, for coating the exterior of the structure along with applying outer layers of any suitable materials, such as again providing natural fiber or textile layers 92/94. As shown, a first formation stage includes a first pair of upper 126 and lower 128 manifolds arranged in communication with a central perimeter die 130 for forming the binder matrix, such as a polyethylene foam around a plurality of individually arrayed and elongated fed substrate articles.

As previously depicted in FIG. 5, the plurality of elongated bamboo rods 40-54 are utilized in the process of FIG. 18 and are arranged for passage through the first die 130. The first extrusion die 130 can also inject any of a rigid and expanded foam material (again as previously described in FIG. 4) and can include any catalyst which will expedite setting and hardening prior to passage through a second stage die which, as previously described, can include previously described upper 12 and lower 14 manifolds which are in communication with the plastic perimeter extrusion die (again previously at 16).

In this fashion, the structural created plank, such as which is again further represented by the plurality of individual planks 32, 34, 36 and 38, is advanced into the second extrusion process for exterior coating the polymerized material about the plank article as previously described. In combination, the pinch rollers 80/82 are again utilized for assisting in applying an outer material (see again upper 92 and lower 94 materials which can be applied from rolls 84/86, such as including and not limited to any of a burlap, muslin or canvas for pressing the material into the outer coating plastic (again at 20) by the rollers and without the need for separate adhesives. Following the second process, the polymerized extruded article exits the die and can be sectioned according to given lengths.

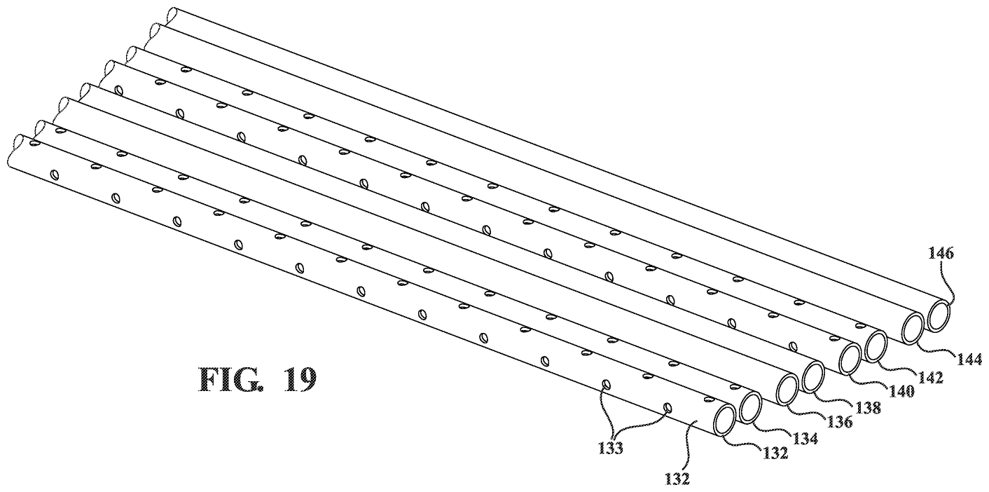

FIG. 19 is a further variant providing for extrusion coating of a polymerized material (not shown) about an exterior of a previously formed three-dimensional rectangular article (also not shown in this illustration), such as which can further incorporate a bamboo framework, see individual lengths 132, 134, 136, 138, 140, 142, 144 and 146 which are arranged in side-by-side fashion prior to being encapsulated within a rigid and expandable foam matrix (also not shown in this view). As further shown, apertures can be formed into the individual bamboo lengths (see for example at 133 for bamboo length 132). The apertures can also allow for flow-through of the structural foam or other materials to the hollow interiors of the individual lengths, this in order to increase the structural rigidity of the completed article. Additionally or alternatively, a key characteristic provides that a variant of bamboo is perforated to allow the polymeric material to penetrate the internodal cavities of the bamboo.

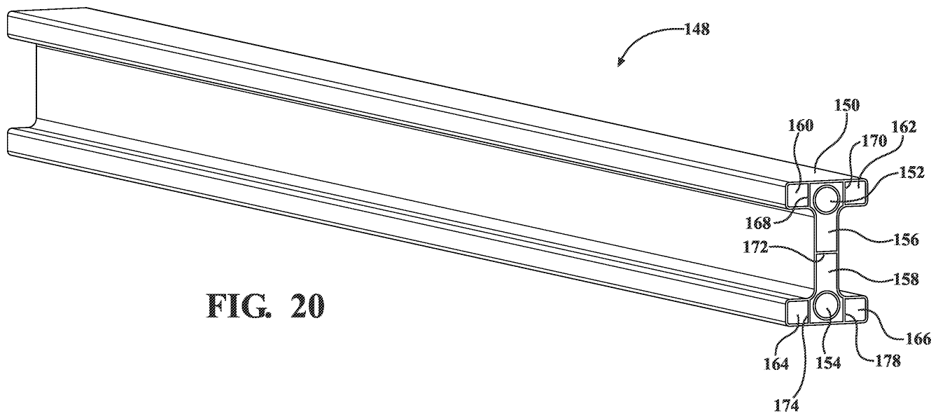

FIG. 20 is an illustration, generally at 148, of a further variant providing for extrusion coating of a polymerized material 150 about an exterior of a previously formed I beam cross sectional shaped article, such as which can further incorporate individual bamboo lengths 152 and 154 encapsulated within a rigid and expandable foam matrix, these are shown by individual sections of foam matrix 156, 158, 160, 162, 164 and 166 which are separated by interior structural reinforcing locations 168, 170, 172, 174 and 176.

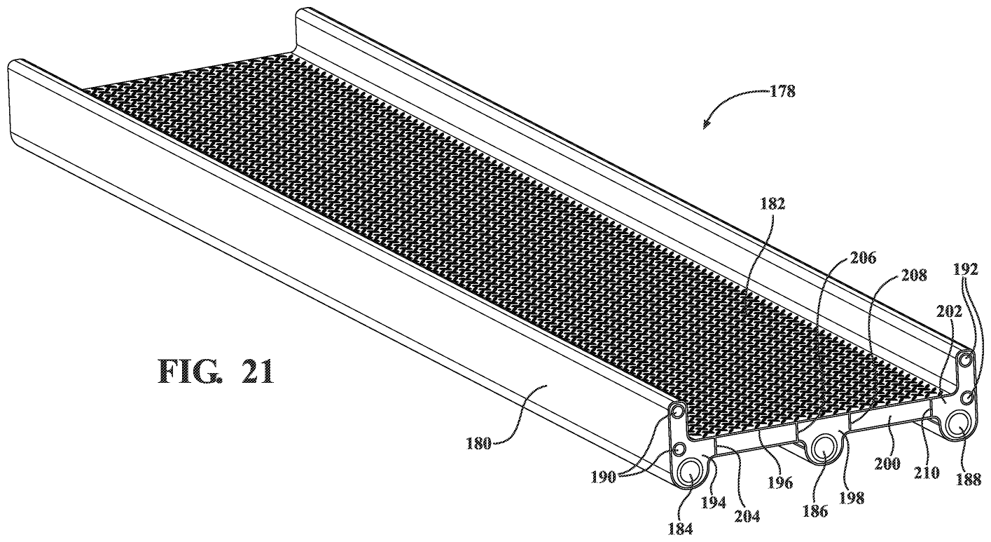

FIG. 21 is an illustration of a further variant, generally at 178 providing for extrusion coating of a polymerized material 180 with a textured or embossed outer pattern (see as shown at 182) about an exterior of a previously formed panel shaped or walkway defining structural article. The structural framework can further incorporate an arrangement of individual lengths of bamboo (see larger at 184, 186, 188 and pairs of smaller bamboo lengths 190 and 192 proximate opposite sides) encapsulated within a rigid and expandable foam matrix (individual sections 194, 196, 198, 200 and 202 which are separated by individual internal reinforcing locations 204, 206, 208 and 210. As further shown, the configuration of the elongated article can include raised side locations or any other desired shape or profile.

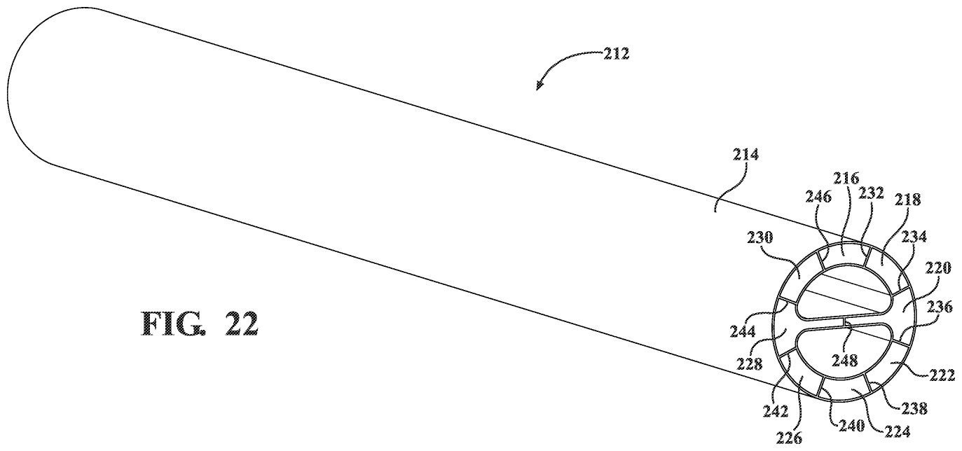

FIG. 22 is an illustration, generally at 212, of a further variant providing for extrusion coating of a polymerized material (or any other outer applicant designated by surface 214) about a circular cross sectional shaped and interiorly hollow structural article, such as which can be encapsulated within a rigid and expandable foam matrix including individual sections 216, 218, 220, 222, 224, 226, 228 and 230 (seconds 220 and 228 further collectively defining an interior diameter reinforcement connection). The individual expandable foam sections can again be separated by reinforced interior locations 232, 234, 236, 238, 240, 242, 244, 246 and 248 (interior central connection).

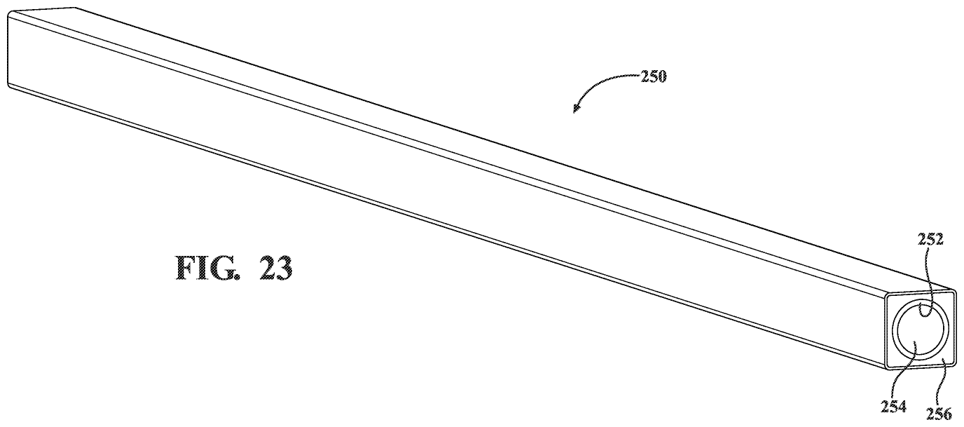

FIG. 23 is an illustration of a further variant, generally at 250, providing for extrusion coating a polymerized material about a square, rectangular or other polygonal cross sectional shaped article (generally at 252), and which can include a length of a bamboo article or other coextruded hollow tubular structure, such as which can be encapsulated within a rigid and expandable foam matrix (see inner 254 and outer 256 portions). Although not shown, any suitable polymerized material as previously described in each of the process views can be applied over any of the structural articles depicted herein.

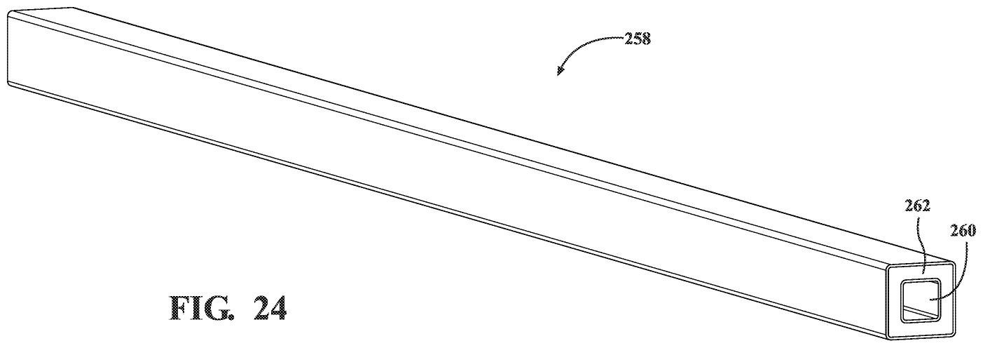

FIG. 24 is an illustration of a further variant 258 providing for extrusion coating of a polymerized material about a square shaped article (see at 260) such including a length of any suitable bamboo or other material not limited to a coextruded hollow tubular structure and which can be encapsulated within a rigid and expandable foam matrix 262.

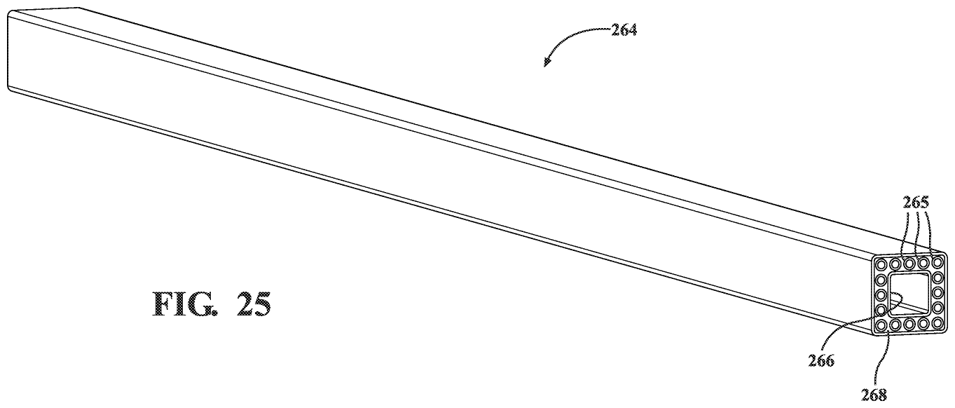

FIG. 25 is an illustration of a further variant 264 providing for extrusion coating of a polymerized material, including bamboo or other coextruded hollow tubular structure, about an arrayed plurality of bamboo articles 265 (these positioned around a rectangular cross sectional shaped and central located article 266), and such as which can again be encapsulated within a rigid and expandable foam matrix 268.

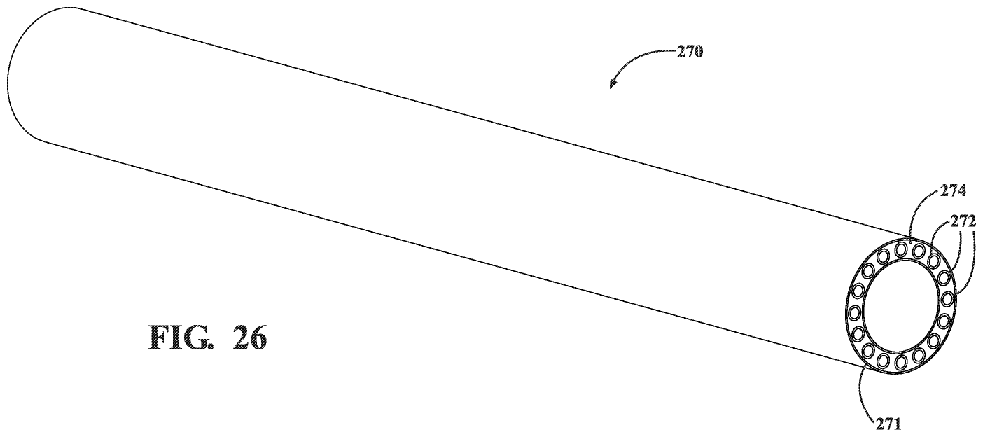

Lastly, FIG. 26 is a related variant to that depicted in FIG. 25 and showing a circular cross-sectional article 270 according to a still further variant and providing for extrusion coating of a polymerized material 271 about an alternately arrayed plurality of bamboo stalks 272, such as which can again be encapsulated within a rigid and expandable foam matrix 274.

Having described my invention, other and additional preferred embodiments will become apparent to those skilled in the art to which it pertains, and without deviating from the scope of the appended claims.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

I claim:

1. An assembly for forming any structural, insulative or decorative article, comprising:
a width extending extrusion die through which is continuously fed a plank shaped body;
a nozzle incorporated into said die extrusion for coating a polymerized material around at least an exterior of said body; and
said die forming first and second interlocking profiles along each of opposite side edges of said body and such that a plurality of said bodies are interlocking assembled into any of a wallboard, ceiling board or floorboard application.

2. The assembly of claim 1, further comprising a pair of opposing and rotating pinch rollers for adhering a layer unwound from a material roll against said polymerized material in at least a partially molten state and at a given pressure to cause said polymerized material to fuse and embed within the unwound material layer.

3. The assembly of claim 1, said polymerized material further comprising any of a polyurethane, polypropylene or other composite material.

4. The assembly of claim 2, said material roll further comprising a first upper material roll and a second lower material roll and said unwound layer further including an upper layer and a lower layer.

5. The assembly of claim 2, said material roll further comprising a coarse material not limited to any of a jute/burlap, hemp, ramie, bamboo, cotton, linen, silk, sisal, piassava, afla, bagasse, banana, pineapple, acacia, coconut, kenaf, wool, abaca, nettle, coir, cashmere, biuriti, muslin or canvas.

6. The assembly of claim 2, said material roll further comprising an organic fabric treated with any combination of additives or blowing agents to provide the structural, insulation or decorative article with any of fire retardant, antimicrobial or water-resistant capabilities.

7. The assembly of claim 2, said material roll further comprising a film, poly spun, vinyl, fabric, coilable, Fiberglass Reinforced Plastic (FRP), cloth, laminate, crosslinked foam laminate, scrim, weaving, mats, mesh, pulp or paper.

8. The assembly of claim 2, said material roll further comprising any of a carpet, liner or other acoustic dampening material, natural fiber or fibrous material for bonding to said polymeric material.

9. The assembly of claim 2, said material roll further comprising a wood veneer.

10. The assembly of claim 1, further comprising a sectioning assembly located downstream of said width extending die for incising said article into said individual bodies.

11. The assembly of claim 1, said plank shaped body further comprising a preformed structural rigid foam material.

12. The assembly of claim 11, further comprising any of reeds, bamboo, rattan stems, horsetail, reed sticks, or ground corn incorporated into said structural rigid foam material.

13. The assembly of claim 1, said plank shaped body further comprising an assembled bamboo framework in which said framework is perforated to allow said polymerized material to penetrate internodal cavities thereof.

14. The assembly of claim 1, said plank shaped body further comprising rods positioned in opposing and plural tier defining fashion.

15. The assembly of claim 14, further comprising said individual tiers of said rods being arrayed in cross wise extending direction to strengthen said body.

16. The assembly of claim 1, further comprising a second and prior width extrusion die associated with a second extrusion process for preforming said plank shaped body and including injecting a structural rigid foam around an elongated substrate material.

17. The assembly of claim 1, said first and second interlocking profiles further comprising an angled ledge and parallel spaced and extending spacer portions extruded along a first side edge of each of said bodies, a mating and mirror positioned angled ledge extruded along the other side edge of said body.

18. A process for forming a structural, insulation or decorative article, comprising the steps of:
translating an elongated body through a die;
extruding a polymerized material around said body; and
said step of extruding further including forming first and second interlocking profiles along each of opposite side edges of said body such that a plurality of said bodies are interlocking assembled into any of a wallboard, ceiling, board or floorboard application.

19. The process of claim 18, further comprising the step of assembling an interior framework of elongated materials in order to pre-form said elongated body.

20. The process of claim 19, further comprising the step of incorporating a composite material associated with either said body or said polymerized materials.

21. The process of claim 20, said step of incorporating a composite material further comprising incorporating any one or more of polymer/composites, sawdust, foam, gypsum or cellulose matrix, wooden core material, bamboo, or any other structural grasses including rattan stems, horsetail or reed sticks, ground corn cobs, metal or composite framework encapsulated within said matrix.

22. The process of claim 20, said step of incorporating said composite material further comprising said material being formed inline continuously in a step preceding extrusion coating of the polymerized material.

23. The process of claim 20, said step of incorporating said composite material further comprising said composite material matrix being formed in a separate line process feeding into the extrusion coating of the polymerized material.
